(19) United States
(12) Patent Application Publication
(10) Pub. No.: US 2012/0012134 A1
(43) Pub. Date: Jan. 19, 2012

(54) METHOD FOR CLEANING ELECTRONIC MATERIAL AND DEVICE FOR CLEANING ELECTRONIC MATERIAL

(75) Inventors: Kazumi Tsukamoto, Tokyo (JP); Hiroshi Morita, Tokyo (JP)

(73) Assignee: Kurita Water Industries Ltd., Tokyo (JP)

(21) Appl. No.: 13/138,697

(22) PCT Filed: Mar. 4, 2010
(86) PCT No.: PCT/JP2010/053527

§ 371 Date: Sep. 20, 2011

(30) Foreign Application Priority Data
Mar. 31, 2009 (JP) 2009-086347

(51) Int. Cl. B08B 3/08; B08B 7/00

(52) U.S. Cl. 134/1.3; 134/28; 134/94.1

(57) ABSTRACT

A resist on an electronic material is surely separated and removed in a short time. The electronic material is cleaned with a sulfuric acid solution containing persulfuric acid to separate and clean the resist, and thereafter wet cleaning is performed with gas dissolved water. By using gas dissolved water for performing wet cleaning after the resist separation with the sulfuric acid solution containing persulfuric acid, the time required for cleaning can be sharply reduced as compared with that of a former method. The sulfuric acid solution containing persulfuric acid is preferably one produced by electrolyzing a sulfuric acid solution. A sulfuric acid solution which is discharged from a resist separation and cleaning device and in which the persulfuric acid concentration has decreased is supplied to an electrolytic reactor for regeneration, and then the sulfuric acid solution, in which the persulfuric acid concentration has been sufficiently increased, is circulated to the cleaning device, whereby the resist can be efficiently separated and removed with the high-concentration persulfuric acid and the repeated use of the sulfuric acid can be achieved.

### FIELD OF INVENTION

The present invention relates to a cleaning method and a cleaning device for efficiently separating and removing a resist on an electronic material in manufacturing processes of electronic components, such as semiconductor substrates, liquid crystal displays, organic EL displays, and photomasks therefor.

### BACKGROUND OF INVENTION

Heretofore, the separation and cleaning of a resist on an electronic material in the field of manufacturing semiconductor substrates, liquid crystal displays, organic EL displays, and photomasks therefor, and the like are usually performed in the order of “SPM cleaning”→“Rinse cleaning”→“APM cleaning”→“Rinse cleaning ”→“HPM cleaning”→“Rinse cleaning”→“DHF cleaning”→“Rinse cleaning”→“Drying”.

More specifically, to an electronic material with a resist, the resist is first separated by SPM cleaning using a sulfuric acid solution containing persulfuric acid (SPM) obtained by mixing sulfuric acid and hydrogen peroxide solution. Therefore, wet cleaning, such as APM cleaning with an aqueous ammonia.hydrogen peroxide solution (APM), HPM cleaning with an aqueous hydrochloric acid.hydrogen peroxide solution (HPM), or DHF cleaning with diluted hydrofluoric acid (DHF), is performed. Thereafter, drying is performed to thereby complete a series of cleaning treatment. Between the respective cleaning processes using different chemical solutions, rinse cleaning using pure water is performed. The HPM cleaning and DHF cleaning are sometimes omitted.

In recent years, in the field of manufacturing electronic materials, such as semiconductor substrates, liquid crystal displays, and organic EL displays, the manufacturing processes of the electronic materials are complicated with a reduction in size, an increase in functionality, and an increase in performance of the electronic materials and the resist separation treatment of the electronic materials has become difficult. Moreover, the amount of chemical solutions for use in the resist separation treatment becomes large, which has posed a problem of disposing of waste liquid discharged from the resist separation treatment process.

For example, in recent years, the injection amount of ions to be injected into electronic materials, such as silicon substrates, tends to increase with a reduction in size of LSI. When the ion injection amount increases, the treatment for separating a resist from the electronic materials becomes difficult. Therefore, it is necessary to perform ashing treatment (ashing treatment of the resist with oxygen plasma or the like) prior to the separation treatment of the resist, which increases the number of processes. The amount of SPM required for the SPM cleaning also tends to increasingly increase in recent years.

In the resist separation treatment by SPM cleaning, cleaning is performed while maintaining oxidation power by periodically adding a hydrogen peroxide solution to sulfuric acid. However, the continuous use reduces the sulfuric acid concentration due to dilution with the hydrogen peroxide solution. Therefore, a replacement with a high concentration sulfuric acid solution is periodically required.

In contrast thereto, it has been proposed to use a sulfuric acid solution containing persulfuric acid produced by electrolyzing a sulfuric acid solution as a cleaning liquid, collect the used cleaning liquid, and electrolyze the same again for reusing (e.g., Patent Documents 1 and 2). According to the method, the oxidation power can be easily maintained at a level equal to or higher than a certain level and additional injection of a chemical solution or replacement of a chemical solution is hardly performed, and therefore a considerable reduction in the amount of chemical solutions has been expected. Moreover, since a cleaning liquid having high oxidation power can be continuously produced, it has been expected to achieve separation and cleaning not including the ashing treatment (ashing-less cleaning).

### Prior Art Documents

### Patent Documents

Patent Document 1: Japanese Patent Publication 2006-114880 A

Patent Document 2: Japanese Patent Publication 2007-266495 A

### OBJECT AND SUMMARY OF INVENTION

### Object of Invention

As described above, since the manufacturing process has become complicated with a recent reduction in size, a recent increase in functionality, and a recent increase in performance of electronic materials, a higher resist separating capability has been demanded and an increase in the SPM consumption amount has posed a problem of disposing of the waste liquid thereof. Moreover, the time required for manufacturing tends to be prolonged due to the complicated manufacturing process, and therefore it has been demanded to shorten the time required for each process including the resist separation treatment.

Moreover, when a resist is separated and cleaned in an ashing-less manner using a sulfuric acid solution containing persulfuric acid obtained by electrolyzing a sulfuric acid solution, a resist residue which has not been separated is likely to remain on electronic materials. Therefore, it has been desired to surely remove the residue in a short time in wet cleaning in a later stage.

The present invention has been made in view of the above-described former circumstances. It is an object of the invention to provide an electronic material cleaning method and an electronic material cleaning device that shortens time required for separation treatment of a resist on an electronic material. It is another object of the invention to provide an electronic material cleaning method and an electronic material cleaning device that can surely remove a resist residue in a short time by wet cleaning after resist separation in ashing-less cleaning.

### SUMMARY OF INVENTION

An electronic material cleaning method of a first embodiment includes, in an electronic material cleaning method including separating and removing a resist on an electronic material, a resist separation process for bringing a sulfuric acid solution containing persulfuric acid into contact with an electronic material to separate the resist and a wet cleaning process for bringing gas dissolved water into contact with the electronic material after separating the resist for cleaning.

In an electronic material cleaning method of a second embodiment, the sulfuric acid solution containing persulfuric acid is produced by electrolyzing a sulfuric acid solution in the first embodiment.

In an electronic material cleaning method of a third embodiment, at least an anode of electrodes for use in the electrolysis is a conductive diamond electrode in the second embodiment.

In an electronic material cleaning method of a fourth embodiment, the gas dissolved water is irradiated with ultrasonic waves in the wet cleaning process in any one of the first to third embodiments.

In an electronic material cleaning method of a fifth embodiment, gas which is dissolved in the gas dissolved water is at least one selected from the group consisting of ozone gas, hydrogen gas, oxygen gas, nitrogen gas, carbonic acid gas, and rare gas in any one of the first to fourth embodiments.

In an electronic material cleaning method of a sixth embodiment, the gas dissolved water is gas dissolved water in which at least one selected from the group consisting of hydrogen gas, oxygen gas, nitrogen gas, and rare gas is dissolved and contains alkali in the fifth embodiment.

In an electronic material cleaning method of a seventh embodiment, the gas dissolved water is gas dissolved water in which ozone gas is dissolved and contains acid in the fifth embodiment.

In an electronic material cleaning method of an eighth embodiment, the electronic material with which the sulfuric acid solution containing persulfuric acid is brought into contact is an electronic material which is not subjected to ashing treatment in any one of the first to seventh embodiments.

An electronic material cleaning device of a ninth embodiment includes, in an electronic material cleaning device that separates and removes a resist on an electronic material, resist separating means for bringing a sulfuric acid solution containing persulfuric acid into contact with the electronic material to separate the resist and wet cleaning means for bringing gas dissolved water into contact with the electronic material after separating the resist for cleaning.

An electronic material cleaning device of a tenth embodiment has an electrolytic reactor for electrolyzing a sulfuric acid solution to thereby produce the sulfuric acid solution containing persulfuric acid in the ninth embodiment.

In an electronic material cleaning device of an eleventh embodiment, at least an anode of electrodes in the electrolytic reactor is a conductive diamond electrode in the tenth embodiment.

An electronic material cleaning device of a twelfth embodiment has ultrasonic wave irradiation means for irradiating the gas dissolved water during wet cleaning with ultrasonic waves in any one of the ninth to eleventh embodiments.

An electronic material cleaning device of a thirteenth embodiment has a gas dissolved water producing device for dissolving at least one selected from the group consisting of ozone gas, hydrogen gas, oxygen gas, nitrogen gas, carbonic acid gas, and rare gas in water in any one of the ninth to twelfth embodiments.

In an electronic material cleaning device of a fourteenth embodiment, the gas dissolved water producing device is a device for dissolving at least one selected from the group consisting of hydrogen gas, oxygen gas, nitrogen gas, and rare gas in water and has means for adding alkali to water before dissolving gas, during dissolving gas, or after dissolving gas in the thirteenth embodiment.

In an electronic material cleaning device of a fifteenth embodiment, the gas dissolved water producing device is a device for dissolving ozone gas in water and has means for adding acid to water before dissolving gas or during dissolving gas in the thirteenth embodiment.

In an electronic material cleaning device of a sixteenth embodiment, the electronic material with which the sulfuric acid solution containing persulfuric acid is brought into contact is an electronic material which is not subjected to ashing treatment in any one of the ninth to fifteenth embodiments.

### Advantageous Effects of Invention

According to the present invention, the time required for cleaning can be sharply shortened as compared with that of former methods by using gas dissolved water for performing wet cleaning after resist separation with a sulfuric acid solution containing persulfuric acid.

More specifically, as compared with APM or HPM which has been used for wet cleaning, the gas dissolved water can achieve high cleaning power and can shorten the following rinse time or eliminate the necessity of rinse cleaning. Moreover, since the cleaning power in wet cleaning is high, the separation and cleaning time with the sulfuric acid solution containing persulfuric acid in the former stage can also be shortened and further ashing-less cleaning can also be achieved. As a result, the treatment time for a series of resist separation can be sharply shortened as compared with that of former methods.

Moreover, by the omission of processes or the shortening of the treatment time, the consumption amount of chemical solutions and the amount of waste liquid can also be reduced. As a result, the manufacturing cost of electronic materials can be lowered.

The sulfuric acid solution containing persulfuric acid for use in the invention is preferably one produced by electrolyzing a sulfuric acid solution. Thus, by supplying a discharged cleaning liquid (a sulfuric acid solution in which the persulfuric acid concentration has decreased) from a resist separation and cleaning device to the electrolytic reactor for regeneration, and then circulating the sulfuric acid solution, in which the persulfuric acid concentration is sufficiently increased, to the cleaning device, the resist can be efficiently separated and removed with the high-concentration persulfuric acid and the repeated use thereof can be achieved.

By using a conductive diamond electrode for at least anode among electrodes in the electrolysis of the sulfuric acid solution, the durability of the electrode can be improved.

In the invention, the gas dissolved water during wet cleaning may be irradiated with ultrasonic waves. The ultrasonic wave irradiation increases the wet cleaning effects and allows more efficient cleaning.

Preferable as the gas dissolved water for use in the wet cleaning are ozone gas dissolved water, hydrogen gas dissolved water, oxygen gas dissolved water, nitrogen gas dissolved water, carbonic acid gas dissolved water, rare gas dissolved water, and the like.

Moreover, the cleaning power can also be increased by adding alkali to hydrogen gas, oxygen gas, nitrogen gas, or rare gas dissolved water. Furthermore, in the case of ozone dissolved water, the cleaning power can also be increased by adding acid.

In the invention, due to the excellent cleaning effects, the cleaning method of the invention can also be applied to electronic materials which have not been subjected to ashing treatment. Also in this case, a resist residue on an electronic material can be surely separated and removed in a short time by wet cleaning with gas dissolved water. In particular, by performing ashing-less cleaning when the sulfuric acid solution containing persulfuric acid is produced by the electrolysis of a sulfuric acid solution, the time required for a series of resist separation treatment can be further shortened and more efficient cleaning can be performed.

### DESCRIPTION OF EMBODIMENTS

Hereinafter, embodiments of an electronic material cleaning method and an electronic material cleaning device of the invention will be described in detail.

### [Electronic Material]

In the invention, an electronic material to be cleaned is an electronic material on which a resist pattern is formed in manufacturing processes of, for example, semiconductor substrates, liquid crystal displays, organic EL displays, photomasks therefor, and the like. In usual, the thickness of a resist film on the electronic material is about 0.1 to 2.0 μm but is not limited to the thickness at all.

### [Ashing Treatment]

Prior to performing the resist separation and cleaning according to the invention, ashing treatment may be performed. The ashing treatment is performed by performing incineration treatment of the resist on the electronic material with oxygen plasma or the like according to a standard method. In the invention, when a sulfuric acid solution containing persulfuric acid produced by the electrolysis of a sulfuric acid solution is used, the resist can be surely cleaned and removed without causing a problem of a resist residue even when the ashing treatment is omitted. The omission of the ashing treatment can sharply reduce the time and the cost required for a series of resist separation treatment.

### [Separation and Cleaning of Resist]

In the invention, the ashing treatment is performed, as required, using an electronic material with a resist as a material to be cleaned, and thereafter separation and cleaning of the resist by the sulfuric acid solution containing persulfuric acid and wet cleaning with gas dissolved water are performed. Between these cleaning processes, rinse cleaning may be performed.

The cleaning method of the separation cleaning and the wet cleaning may be any method of a batch method in which a plurality of electronic materials are collectively cleaned or a single wafer method in which a plurality of electronic materials are treated one by one.

The batch cleaning is usually performed by immersing a plurality of electronic materials in a cleaning liquid in a cleaning bath. In contrast, the single wafer method is usually performed by spin cleaning, in which a cleaning liquid is poured to the surface of an electronic material while rotating the electronic material, or the like.

<Separation and Cleaning with Sulfuric Acid Solution Containing Persulfuric Acid>

The persulfuric acid generated in the invention represents peroxomonosulfuric acid (H₂SO₅) and peroxodisulfuric acid (H₂S₂O₈). Both of the peroxomonosulfuric acid and the peroxodisulfuric acid have high oxidation power.

The peroxomonosulfuric acid can be generated by a reaction of sulfuric acid and a little excessive amount of hydrogen peroxide.

H₂SO₄+H₂O₂→H₂SO₅+H₂O

In contrast, the peroxodisulfuric acid can be generated by electrolytic oxidation of a sulfuric acid solution.

2SO₄²⁻→S₂O_{B}²⁼+2e−

or

2HSO₄⁻→S₂O₈²⁻+2H⁺+23⁻

When generating the peroxodisulfuric acid by the electrolytic oxidation of a sulfuric acid solution, a conductive diamond electrode having heat resistance, acid resistance, and oxidation resistance is preferably used as at least the anode among electrodes in order to prevent the elution of impurities from the electrodes.

Moreover, a peroxodisulfuric acid ion (S₂O₈²⁻) is excited and self-decomposed in response to strong energy, such as ultraviolet ray irradiation or high temperature heating, to generate a sulfuric acid radical (SO₄·⁻).

S₂O₈²⁻→2SO₄·⁻

Due to the high oxidation power of the generated sulfuric acid radical, the resist is removed from the electronic material.

2SO₄·^{-+e}⁻→SO ₄²⁻

It is considered that, in a resist separation and cleaning process in which a sulfuric acid solution containing persulfuric acid is brought into contact with an electronic material with a resist which is a material to be cleaned, the peroxodisulfuric acid ion in the sulfuric acid solution containing persulfuric acid is self-decomposed to generate a sulfuric acid radical, and the resist, other contaminants, and the like on the electronic material is/are efficiently separated and removed due to the oxidation power of the sulfuric acid radical.

The sulfuric acid concentration of the sulfuric acid solution to be electrolyzed is about 8 to 18 M and particularly preferably about 12 to 17 M. When the sulfuric acid concentration of the sulfuric acid solution is excessively low, the resist dissolution power of the sulfuric acid solution decreases, which makes it difficult to obtain sufficient resist separation effects. Moreover, when the sulfuric acid concentration of the sulfuric acid solution becomes higher than the above-described upper limit, a reduction in ion flux may cause a reduction in the current efficiency or wear of the electrodes. Therefore, such a sulfuric acid concentration is not preferable.

A suitable persulfuric acid concentration of the sulfuric acid solution containing persulfuric acid to be used for cleaning varies depending on electronic materials to be cleaned and is preferably about 1 to 5 g/L in the batch cleaning and about 5 to 30 g/L in the single wafer cleaning. When the persulfuric acid concentration in the sulfuric acid solution containing persulfuric acid is excessively low, the oxidation power is insufficient, which makes it impossible to obtain sufficient resist separation effects. Therefore, the persulfuric acid concentration is preferably higher. However, increasing the persulfuric acid concentration to be higher than the above-described upper limit is not efficient in terms of, for example, the current efficiency in the case of obtaining the sulfuric acid solution containing persulfuric acid by the electrolysis described below.

In the invention, the sulfuric acid solution containing persulfuric acid for use in the resist separation process is preferably one produced by the electrolysis of a sulfuric acid solution (usually one in which sulfuric acid is dissolved in pure water or ultrapure water is usually used as the sulfuric acid solution). Moreover, the sulfuric acid solution which has been used for the resist separation and therefore the persulfuric acid concentration has decreased due to the self-decomposition of the peroxodisulfuric acid ion in the solution is preferably regenerated by electrolysis to be used in a circulation manner. In this case, the sulfuric acid solution in which the persulfuric acid concentration has decreased is supplied to an electrolytic reactor through a circulation line from the cleaning device. In the electrolytic reactor, the anode and the cathode are brought into contact with the sulfuric acid solution, and a current is passed between the electrodes for electrolyzing, thereby oxidizing a sulfuric acid ion or a sulfuric acid hydrogen ion to generate a peroxodisulfuric acid ion, whereby a sulfuric acid solution with a sufficiently high persulfuric acid concentration is regenerated. The regenerated sulfuric acid solution containing persulfuric acid is returned to the cleaning device through the circulation line to be re-used for resist separation and cleaning. Thus, by repeatedly circulating the sulfuric acid solution containing persulfuric acid between the cleaning device and the electrolytic reactor, efficient cleaning can be continuously performed in a state where the persulfuric acid ion composition of the sulfuric acid solution containing persulfuric acid for use in the separation and cleaning is maintained at a high concentration suitable for the resist separation and cleaning.

In the electrolytic reactor of a sulfuric acid solution (also including the sulfuric acid solution containing persulfuric acid), the electrolysis is performed while paring the anode and the cathode. The materials of the electrodes are not particularly limited. When platinum, which is generally widely utilized as an electrode, is used as the anode, there arise problems in that a peroxodisulfuric acid ion cannot be efficiently produced and the platinum elutes. In contrast thereto, when a conductive diamond electrode is used for at least the anode, the conductive diamond electrode has advantages in that the conductive diamond electrode is chemically stable and impurities do not elute in a concentrated sulfuric acid or sulfuric acid solution containing persulfuric acid. The generation of a peroxodisulfuric acid ion from a sulfuric acid ion or a sulfuric acid hydrogen ion with the conductive diamond electrode has been reported under the conditions of a current density of about 0.2 A/cm² (Ch-Comninellis et al., Electrochemical and Solid-State Letters, Vol. 3(2) 77-79 (2000)).

As the conductive diamond electrode, one in which a semiconductor material, such as a silicon wafer, is used as a substrate, and a conductive diamond thin film is synthesized with a film thickness of 20 μm or more on the substrate surface or a self-stand type conductive polycrystalline diamond which is deposited and synthesized in the shape of a plate under the conditions of not using a substrate can be mentioned. The conductive diamond film is one in which conductivity is imparted by doping boron or nitrogen in synthesizing the diamond thin film and one doped with boron is usually common. When the doped amount thereof is excessively small, a technical significance does not arise. When the doped amount is excessively large, the doping effect thereof is saturated. Therefore, one is suitable in which the doped amount thereof is in the range of 50 to 20,000 ppm based on the carbon amount of the diamond thin film. In the invention, a plate-like conductive diamond electrode is used as the conductive diamond electrode but one in which a net structure is formed into the shape of a plate can also be used.

In the electrolysis treatment in the electrolytic reactor, it is desirable that the current density of the conductive diamond electrode surface is adjusted to 10 to 100,000 A/m² and a sulfuric acid solution is brought into contact therewith in parallel to the diamond electrode surface at a linear velocity of the supplied liquid of 10 to 10,000 m/h.

In the invention, when the temperature of the sulfuric acid solution containing persulfuric acid to be used is excessively low in the resist separation and cleaning using the sulfuric acid solution containing persulfuric acid, sufficient cleaning effects cannot be obtained. When the temperature thereof is excessively high, the sulfuric acid solution boils, depending on the sulfuric acid concentration or the like. Therefore, the temperature is preferably about 100 to 180° C.

The time of the resist separation and cleaning with the sulfuric acid solution containing persulfuric acid is not particularly limited and varies depending on a resist adhesion state of a material to be cleaned, the existence of the ashing treatment prior to the separation and cleaning treatment, the persulfuric acid concentration or the solution temperature of the sulfuric acid solution containing persulfuric acid, the conditions of a subsequent wet cleaning process, and the like. In usual, the time is preferably adjusted to about 5 to 30 minutes and particularly preferably about 10 to 20 minutes in the batch cleaning and is preferably adjusted to about 20 to 300 seconds and particularly preferably about 30 to 120 seconds in the single wafer cleaning.

As described above, a preferable temperature for the resist separation and cleaning with the sulfuric acid solution containing persulfuric acid is 100 to 180° C. When the above-described electrolysis temperature is excessively high, the electrolysis efficiency decreases and wear of electrodes also increases. However, when the electrolysis temperature is excessively lowered, the heating energy when used for the resist separation and cleaning becomes high. Therefore, the temperature of the solution to be electrolyzed by the electrolytic reactor is preferably 10 to 90° C. and particularly preferably 40 to 80° C.

Therefore, when the sulfuric acid solution is circulated by the cleaning device and the electrolytic reactor, it is preferable to provide a heat exchanger in the circulation line to thereby cool the sulfuric acid solution to be supplied to the electrolytic reactor and to heat the sulfuric acid solution containing persulfuric acid to be supplied to the cleaning device.

<Rinse Cleaning>

After the resist separation and cleaning with the above-described sulfuric acid solution containing persulfuric acid, wet cleaning with gas dissolved water is performed. Between the resist separation and cleaning process and the wet cleaning process, rinse cleaning with rinse water may be performed. However, the rinse cleaning is not indispensable and wet cleaning may be performed without performing the same.

When performing a rinse process, ultrapure water is usually used as the rinse water.

The ultrapure water in the invention is pure water satisfying all of the following conditions.

Electrical resistivity: 18 MQ·cm or more

Metal ion concentration: 5 ng/L or lower

Remaining ion concentration: 10 ng/L or lower

Number of fine particles: 5 or lower of fine particles of 0.1 μm or more in 1 mL.

TOC: 0.1 to 10 μg/L

The same applies to the rinse process performed between cleaning processes with different kinds of gas dissolved water in the wet cleaning described later.

The rinse process may be performed by a batch method or may be performed by a single wafer method. When the temperature of the rinse water is excessively low, sufficient rinse effects cannot be obtained. When the temperature of the rinse water is excessively high, the energy efficiency is poor. Therefor, the temperature of the rinse water is preferably 10 to 90° C. and particularly preferably 60 to 80° C.

Moreover, the time required for the rinse process varies depending on the kind of the processes before and after the rinse process. For example, in the case of a rinse process between separation and cleaning with the sulfuric acid solution containing persulfuric acid in the case of ashing-less cleaning and wet cleaning with gas dissolved water, the time is preferably about 5 to 30 minutes and particularly preferably about 10 to 20 minutes in the batch cleaning and is preferably about 20 to 300 seconds and particularly preferably about 30 to 120 seconds in the single wafer cleaning. In the case of a rinse process between separation and cleaning with the sulfuric acid solution containing persulfuric acid after performing the ashing treatment and wet cleaning with gas dissolved water, the time is preferably about 3 to 20 minutes and particularly preferably about 5 to 10 minutes in the batch cleaning and is preferably 20 to 200 seconds and particularly preferably about 30 to 60 seconds in the single wafer cleaning. The rinse process in this case may be omitted.

Moreover, in the case of a rinse process between cleaning processes with different kinds of gas dissolved water in the wet cleaning process, the time is preferably about 20 minutes or lower and particularly preferably about 3 to 5 minutes in the batch cleaning and is preferably 60 seconds or lower and particularly preferably about 10 to 30 seconds in the single wafer cleaning. The rinse process in this case may be omitted.

<Wet Cleaning with Gas Dissolved Water>

In the invention, gas dissolved water is used as wet rinse water, and efficient wet cleaning is performed by the oxidation power of the gas dissolved water. Usable as gas dissolved in the gas dissolved water are ozone gas, hydrogen gas, oxygen gas, nitrogen gas, carbonic acid gas, and rare gas, such as, Xe, Kr, Ar, Ne, and He. In the gas dissolved water, only one kinds thereof may be dissolved and two or more kinds thereof may be dissolved.

The amount of the dissolved gas in the gas dissolved water is not particularly limited. When the dissolved gas amount is excessively small, sufficient cleaning effects cannot be obtained. However, it is difficult in terms of the solubility of gas in water to excessively increase the dissolved gas amount. Therefore, the dissolved gas amount is preferably about 10 to 100% and particularly preferably about 50 to 90% of the saturated solubility of gas to be dissolved as the total amount of the dissolved gas amount in the gas dissolved water.

Usable as water in which these gases are dissolved are pure water, ultrapure water, degassed water, and the like.

The gas dissolved water can be produced by, for example, degassing ultrapure water with a degassing membrane device, and then dissolving gas using a dissolving membrane device, which supplies the gas to the degassed water through a gas permeation film, or the like.

To the above-described kinds of gas dissolved water, particularly a hydrogen gas dissolved water, an oxygen gas dissolved water, a nitrogen gas dissolved water, and a rare gas dissolved water, alkali may be added to increase the cleaning power. The addition of alkali can control re-adhesion of fine particles by control of a zeta potential or an electrostatic repulsion action, so that wet cleaning effects can be increased.

The alkali to be added to the gas dissolved water is not particularly limited and ammonia is preferably used because, even when ammonia remains after cleaning, ammonia can be evaporated and removed by a drying process. Another alkali, such as TMAH (tetra-methyl ammonium hydroxide), choline, NaOH, or KOH, may be acceptable.

When the alkali addition amount is excessively small, the cleaning power improvement effect due to the addition of alkali cannot be sufficiently obtained. When the alkali addition amount is excessively large, the time required for rinse cleaning for removing alkali is prolonged or the chemical cost is high. Therefore, alkali is preferably added in such a manner that the alkali concentration of the gas dissolved water is 0.1 to 100 mg/L and particularly 1 to 10 mg/L and the pH is 8 to 11 and particularly about 9 to 10.

There is no difference in the alkali adding effect even when alkali is added to gas dissolved water after dissolving gas, alkali is added to water before dissolving gas, or alkali is added to water in which gas is being dissolved.

Moreover, acid may be added to an ozone gas dissolved water to thereby increase the cleaning power. The addition of acid to an ozone gas dissolved water suppresses the self-decomposition of the ozone to maintain the ozone gas concentration in the ozone gas dissolved water, so that the oxidation power of the ozone gas dissolved water is maintained and moreover an oxidation-reduction potential increases due to the fact that the pH is acidic to thereby promote the metal removing effect.

The acid to be added to the ozone gas dissolved water is not particularly limited and carbonic acid is preferable for the same reason as in the case of ammonia. Another acid, such as hydrochloric acid, may be acceptable.

When the acid addition amount is excessively small, the cleaning power improvement effect due to the addition of acid cannot be sufficiently obtained. When the acid addition amount is excessively large, time required for rinse cleaning for removing acid is prolonged or the chemical cost is high. Therefore, acid is preferably added in such a manner that the acid concentration of the gas dissolved water is 0.1 to 100 mg/L and particularly 3 to 30 mg/L and the pH is 6.9 to 2.0 and particularly about 6.0 to 5.0.

Acid is preferably added before dissolving ozone gas in water or simultaneously with dissolving ozone gas in water.

Moreover, during the wet cleaning with gas dissolved water, the gas dissolved water may be irradiated with ultrasonic waves. In this case, high cleaning effects can be obtained by the physical action of the ultrasonic waves (a shock wave accompanied with the occurrence of cavitation or acceleration). The frequency of the ultrasonic waves to be emitted to the gas dissolved water is not particularly limited and is preferably about 40 kHz to 5 MHz from the viewpoint of a cleaning power improvement effect and preventing a material to be cleaned from being damaged. Ultrasonic waves may be always emitted during wet cleaning or may be emitted only for a given period of time during wet cleaning and may be continuously emitted or intermittently emitted.

The ultrasonic wave irradiation and the addition of acid or alkali may be combined.

In the invention, the wet cleaning with gas dissolved water may be performed by a single-stage cleaning process using only one kind of gas dissolved water, may be a cleaning process of two or more stages using one kind of gas dissolved water, or may be a cleaning process of two or more stages using two or more kinds of gas dissolved water. When using two or more kinds of gas dissolved water, the combination of the gas dissolved water, the cleaning order, or the like is not particularly limited. It is preferable in terms of cleaning effects to perform wet cleaning with ozone gas dissolved water or acid-added ozone gas dissolved water after the above-described separation and cleaning with the sulfuric acid solution containing persulfuric acid, and then to perform wet cleaning with hydrogen gas dissolved water or alkali-added hydrogen gas dissolved water.

As described above, the rinse process may be performed between the wet cleaning processes with different kinds of gas dissolved water or may not be performed. When the final process of the wet cleaning process is a cleaning process with gas dissolved water not containing alkali or acid, the following rinse process can also be omitted.

In the invention, the wet cleaning with gas dissolved water may be performed by a batch method or a single wafer method. When the temperature of the gas dissolved water to be used is excessively low, sufficient cleaning effects cannot be obtained. When the temperature is excessively high, the saturated dissolved gas concentration decreases. Therefore, the temperature of the gas dissolved water is preferably 10 to 80° C. and particularly preferably 20 to 60° C.

When ultrasonic waves are emitted in the batch cleaning, the vibration of the ultrasonic waves may just be transmitted to a cleaning bath storing gas dissolved water. When ultrasonic waves are emitted in the single wafer cleaning (spin cleaning), the vibration of the ultrasonic waves may just be transmitted to a nozzle portion from which gas dissolved water is made to flow.

The time required for the wet cleaning with gas dissolved water is not particularly limited and varies depending on the existence of the ashing treatment prior to the separation and cleaning treatment, the separation and cleaning conditions with the sulfuric acid solution containing persulfuric acid, the conditions, such as the type of gas dissolved water to be used in the wet cleaning or the number of processes of the wet cleaning, and the like. In usual, the time for cleaning with one kind of gas dissolved water is preferably adjusted to about 5 to 10 minutes and particularly preferably about 10 to 15 minutes in the batch cleaning and is preferably adjusted to about 10 to 300 seconds and particularly preferably about 30 to 120 seconds in the single wafer cleaning. Also in the case of cleaning using two or more kinds of gas dissolved water, the time for cleaning with each gas dissolved water is preferably adjusted to about 10 to 60 minutes and particularly preferably about 20 to 40 minutes in the batch cleaning and is preferably adjusted to about 20 to 600 seconds and particularly preferably about 40 to 120 seconds in the single wafer cleaning.

<Drying>

After the above-described wet cleaning, spin drying and IPA drying are performed according to a standard method, thereby completing a series of resist separating and cleaning treatment, and then the electronic material from which the resist has been removed is supplied to the following process.

According to the invention, as is clear from the results of Examples described later, by the use of gas dissolved water having both a cleaning function and a rinse function in place of a former APM or HPM in the wet cleaning after the resist separation process, the time required for wet cleaning, subsequent rinse cleaning, and the like can be shortened, so that the time required for a series of resist separation and removal can be sharply shortened to about ¼ to ½ as compared with that of a former case.

### EXAMPLES

Hereinafter, the invention will be more specifically described with reference to Examples and Comparative Examples.

In the following description, materials to be cleaned for use in resist separation treatment, cleaning conditions common in each Example and each Comparative Example, cleaning chemical agents to be used, and the like are as follows.

<Material to be Cleaned: Substrate with Resist>

Substrate: Silicon disk having a diameter of 200 mm (1E14 atoms/cm² As-doped, Ashing-less)

Resist coating thickness: 1.5 μm

### <Cleaning Conditions (Common in Each Bath Including a Rinse Cleaning Bath)>

Batch cleaning in which a substrate is immersed in a cleaning bath for a given period of time

Number of substrates to be treated per treatment: 50/lot

Number of substrates to be treated per hour: 4 lots/h

Cleaning liquid temperature in a cleaning bath: 120 to 150° C.

### <Chemical Agents and the Like>

Sulfuric acid: Electronic industrial grade 98%,

Hydrogen peroxide: Electronic industrial grade 30%,

SPM: One obtained by mixing 98% by weight of a sulfuric acid solution and 30% by weight a hydrogen peroxide solution with a volume ratio of 5:1. After used in cleaning, hydrogen peroxide is supplied as appropriate to the collected waste cleaning liquid to thereby maintain the conditions of a sulfuric acid concentration of 80% by weight or more, and then the liquid is used in a circulation manner.

Electrolytic sulfuric acid: One obtained by electrolyzing 85% by weight of a sulfuric acid solution (Persulfuric acid concentration of 9 g/L). After used in cleaning, the collected waste cleaning liquid is supplied to an electrolysis cell (a conductive diamond electrode in which the front surface of all of an anode, a cathode, and a bipolar electrode interposed between the anode and the cathode is covered), the liquid is electrolyzed under the conditions of an electrical current density of 50 A/dm², and then the liquid is used in a circulation manner.

Hydrogen gas dissolved water: One in which 1.2 mg/L of hydrogen gas is dissolved in pure water.

Ammonia-added hydrogen gas dissolved water: One obtained by adding 1 mg/L of ammonia to the above-described hydrogen gas dissolved water (pH 9.4, water temperature of 25° C.)

Ozone gas dissolved water: One obtained by dissolving 20 mg/L of ozone gas in pure water (water temperature of 25° C.)

Acid-added ozone gas dissolved water: One obtained by adding 5 mg/L of carbonic acid gas before dissolving the above-described ozone gas (pH 5.2, Water temperature of 25° C.)

Ultrasonic wave irradiation: 1 MHz ultrasonic waves are emitted during wet cleaning

Rinse water: Ultrapure water

APM: One obtained by mixing 29% by weight of ammonia water, 30% by weight of a hydrogen peroxide solution, and ultrapure water with a volume ratio of 1:1:5

Ashing treatment of the substrate with resist was performed under the following conditions.

<Ashing treatment>

Wafer size: 200 mm (φ8 inch) substrate

Ashing method: Microwave plasma (2.45 GHz)

Substrate temperature control: 250° C.

Process gas: Oxygen

Ashing rate: 4.5 μm/min

Wafer treatment method: Single wafer method

Wafer treatment time: 30 seconds/substrate (Total required time of 25 minutes=30 seconds×50 substrates)

### [Examples 1 to 4, Comparative Example 1, 2]

The substrate with resist as a material to be cleaned was subjected to ashing treatment, separation and cleaning and wet cleaning were performed according to the procedure shown in Table 1.

The time of each cleaning process is the time shown in the brackets of Table 1. In all the cases, the resist was completely separated and removed after cleaning.

TABLE 1

| | | | | | Comparative | Comparative |
|---|---|---|---|---|---|---|
| | Example 1 | Example 2 | Example 3 | Example 4 | Example 1 | Example 2 |
| Cleaning | SPM | Electrolytic | Electrolytic | Electrolytic | SPM | Electrolytic |
| procedure | (10 minutes) | sulfuric acid | sulfuric acid | sulfuric acid | (10 minutes) | sulfuric acid |
| | | (5 minutes) | (5 minutes) | (5 minutes) | | (10 minutes) |
| | ↓ | ↓ | ↓ | ↓ | ↓ | ↓ |
| | Rinse | Rinse | Acid-added ozone | Acid-added ozone | Rinse | Rinse |
| | (10 minutes) | (10 minutes) | gas dissolved water | gas dissolved water | (10 minutes) | (10 minutes) |
| | | | (5 minutes) | (5 minutes) | | |
| | ↓ | ↓ | ↓ | ↓ | ↓ | ↓ |
| | Ammonia-added | Ammonia-added | Ammonia-added | Ammonia-added | APM | APM |
| | hydrogen gas | hydrogen gas | hydrogen gas | hydrogen gas | (10 minutes) | (10 minutes) |
| | dissolved water and | dissolved water and | dissolved water and | dissolved water and | | |
| | ultrasonic wave | ultrasonic wave | ultrasonic wave | ultrasonic wave | | |
| | irradiation | irradiation | irradiation | irradiation | | |
| | (5 minutes) | (5 minutes) | (5 minutes) | (5 minutes) | | |
| | ↓ | ↓ | ↓ | ↓ | ↓ | ↓ |
| | Rinse | Rinse | Rinse | Hydrogen gas | Rinse | Rinse |
| | (5 minutes) | (5 minutes) | (5 minutes) | dissolved water and | (10 minutes) | (10 minutes) |
| | | | | ultrasonic wave | | |
| | | | | irradiation | | |
| | | | | (3 minutes) | | |
| Total cleaning | 30 minutes | 25 minutes | 20 minutes | 18 minutes | 40 minutes | 40 minutes |
| time | | | | | | |

As is clear from Table 1, by combining wet cleaning with gas dissolved water after persulfuric acid cleaning with SPM or electrolytic sulfuric acid, the rinse time was able to be shortened, so that the total cleaning time required for the resist separation treatment was able to be shortened by 25 to 55%.

### [Example 5, Comparative Example 3]

Ashing-less cleaning was performed according to the procedure shown in Table 2 without performing ashing treatment of the substrate with resist as a material to be treated.

TABLE 2

| | | Comparative |
|---|---|---|
| | Example 5 | Example 3 |
| Cleaning | Electrolytic | Electrolytic |
| procedure | sulfuric acid | sulfuric acid |
| | (10 minutes) | (10 minutes) |
| | ↓ | ↓ |
| | Rinse | Rinse |
| | (10 minutes) | (10 minutes) |
| | ↓ | ↓ |
| | Ammonia-added hydrogen | APM |
| | gas dissolved water and | (10 minutes) |
| | ultrasonic wave irradiation | |
| | (5 minutes) | |
| | ↓ | ↓ |
| | Rinse | Rinse |
| | (5 minutes) | (10 minutes) |
| Total cleaning | 30 minutes | 40 minutes |
| time | | |

As a result, the resist was able to be completely separated and removed in Example 5 but, in Comparative Example 3, there was a resist residue and complete separation was not able to be performed. The results showed that the resist was able to be completely separated in a short time by the use of gas dissolved water in wet cleaning even in the case where ashing-less cleaning was performed using electrolytic sulfuric acid.

The present invention is described in detail with reference to specific embodiments but it is clear to a person skilled in the art that the invention can be variously modified without deviating from the intention and the scope of the preset invention.

The present invention is based on Japanese Patent Application (Japanese Patent Application No. 2009-086347) filed on Mar. 31, 2009, the entire disclosure of which is hereby incorporated by reference.

1. An electronic material cleaning method for separating and removing a resist on an electronic material, the method comprising:
a resist separation step for bringing a sulfuric acid solution containing persulfuric acid into contact with an electronic material to separate the resist; and
a wet cleaning step for bringing gas dissolved water into contact with the electronic material after separating the resist for cleaning.

2. The electronic material cleaning method according to claim 1, wherein the sulfuric acid solution containing persulfuric acid is produced by electrolyzing a sulfuric acid solution.

3. The electronic material cleaning method according to claim 2, wherein at least an anode of electrodes for use in the electrolysis is a conductive diamond electrode.

4. The electronic material cleaning method according to claim 1, wherein the gas dissolved water is irradiated with ultrasonic waves in the wet cleaning process.

5. The electronic material cleaning method according to claim 1, wherein gas which is dissolved in the gas dissolved water is at least one selected from the group consisting of ozone gas, hydrogen gas, oxygen gas, nitrogen gas, carbonic acid gas, and rare gas and the solubility of the gas is 10 to 100% of the saturated solubility.

6. The electronic material cleaning method according to claim 5, wherein the gas dissolved water is gas dissolved water in which at least one selected from the group consisting of hydrogen gas, oxygen gas, nitrogen gas, and rare gas is dissolved and contains alkali in such a manner that the pH is 8 to 11.

7. The electronic material cleaning method according to claim 5, wherein the gas dissolved water is gas dissolved water in which ozone gas is dissolved and contains acid in such a manner that the pH is 6.9 to 2.0.

8. The electronic material cleaning method according to claim 1, wherein the electronic material with which the sulfuric acid solution containing persulfuric acid is brought into contact is an electronic material which is not subjected to ashing treatment.

9. An electronic material cleaning device for separating and removing a resist on an electronic material, the device comprising:
resist separating means for bringing a sulfuric acid solution containing persulfuric acid into contact with the electronic material to separate the resist; and
wet cleaning means for bringing gas dissolved water into contact with the electronic material after separating the resist for cleaning.

10. The electronic material cleaning device according to claim 9, comprising an electrolytic reactor for electrolyzing a sulfuric acid solution to thereby produce the sulfuric acid solution containing persulfuric acid.

11. The electronic material cleaning device according to claim 10, wherein at least an anode of electrodes in the electrolytic reactor is a conductive diamond electrode.

12. The electronic material cleaning device according to claim 9, comprising ultrasonic wave irradiation means for irradiating the gas dissolved water during wet cleaning with ultrasonic waves.

13. The electronic material cleaning device according to claim 9, comprising a gas dissolved water producing device for dissolving at least one selected from the group consisting of ozone gas, hydrogen gas, oxygen gas, nitrogen gas, carbonic acid gas, and rare gas in water.

14. The electronic material cleaning device according to claim 13, wherein the gas dissolved water producing device is a device for dissolving at least one selected from the group consisting of hydrogen gas, oxygen gas, nitrogen gas, and rare gas in water and has means for adding alkali to water before dissolving gas, during dissolving gas, or after dissolving gas.

15. The electronic material cleaning device according to claim 13, wherein the gas dissolved water producing device is a device for dissolving ozone gas in water and has means for adding acid to water before dissolving gas or during dissolving gas.

16. The electronic material cleaning device according to claim 9, wherein the electronic material with which the sulfuric acid solution containing persulfuric acid is brought into contact is an electronic material which is not subjected to ashing treatment.
